(19) United States
(12) Patent Application Publication
(10) Pub. No.: US 2003/0048417 A1
(43) Pub. Date: Mar. 13, 2003

(54) Method and apparatus for displaying motion pictures

(76) Inventor: Michael Ira Rudnick, San Francisco, CA (US)

Correspondence Address: Michael Ira Rudnick, 312 Texas Street, San Francisco, CA, 94107, US

(21) Appl. No.: 10/216,687

(22) Filed: Aug. 12, 2002

Related U.S. Application Data
(60) Provisional application No. 60/311,127, filed on Aug. 10, 2001.

(51) Int. Cl. G03B 25/00

(52) U.S. Cl. 352/101

(57) ABSTRACT

A method and apparatus for displaying motion pictures. In one embodiment, a cylindrical body with vertical facets and then a motion picture image affixed to each facet (creating a series). In this embodiment, the images are substantially flat against a glossy background, and there is a reflected light source cast upon them. When the cylindrical body is rotated about its longitudinal axis, to the viewer, a reflection of the images “hovers” just above the underlying images, and the spinning (or “flipping”) of the facets produces a “shutter-like” effect, such that each reflected image is replaced by an adjacent one of the series of motion-picture images (to produce a magical animated effect).

### CROSS-REFERENCE TO RELATED APPLICATION

The present application claims the benefit of its prior provisional patent application No. 60/311,127, filed by Michael Rudnick on Aug. 10, 2001 (confirmation #4002); note both applications represent the same invention by the same inventor.

### STATEMENT REGARDING FEDERALLY SPONSORED RESEARCH OR DEVELOPMENT

Not Applicable

### REFERENCE TO SEQUENCE LISTING A TABLE OR A COMPUTER PROGRAM LISTING COMPACT DISK APPENDIX

Not Applicable

### BACKGROUND OF THE INVENTION

A. Field of Endeavor

The present invention relates generally to motion pictures and, more specifically, the present invention relates to devices and methods for viewing motion pictures.

B. Information Known by Inventor (on Related Art)

Typical animated picture technology commonly utilizes film or video/new media, each with associated costs and complexities (like from equipment, maintenance and performance needs). By eliminating these costs and complexities, animated images become more practical and attainable for low-cost novelty items (like zoetropes or praxinoscopes). Furthermore, the simplicity that these alternate methods of producing animated images have, allows for the creation of more simple and durable products (like Michael Rudnick's aeotrope, U.S. Pat. No. 5,760,874).

As can be appreciated by those skilled in the art, the zoetrope motion picture display device has the disadvantage of limiting observation of the motion picture images to the space of the zoetrope's slits, while the praxinoscope motion picture display device has the disadvantage of needing mirrors. Consequently, Michael Rudnick invented his aeotrope, another motion picture device that does not employ the use of film or video/new media, nor the use of slits passing through a field of vision, nor the use of mirrors.

Rather, Michael Rudnick's aetrope motion picture display device includes a clear cylinder with facets spaced apart at periodic intervals. A series of motion pictures are printed on the cylinder, such that when the cylinder is rotated, the motion picture images appear to be animated when viewed through the facets (thereby allowing for a broader range of observation, while avoiding the use of expensive materials).

However, as can be appreciated by those skilled in the art, Michael Rudnick's aetrope has the disadvantage of requiring a substantially clear cylinder through which to observe the animated effect (that limits it from using certain materials). Therefore, what is desired is a motion picture device that eliminates the need for film or video/new media equipment, allows a viewer to observe motion picture images from a wide variety of viewing angles (without using mirrors), and eliminates the need for a clear cylinder.

### BRIEF SUMMARY OF THE INVENTION

A method and apparatus for displaying motion pictures is disclosed. In one embodiment, a cylindrical body with vertical facets and then a motion picture image disposed substantially near a corresponding facet (creating a series). A light source is then cast upon the apparatus, such that each one of the series of images is visible when looking at the exterior of the cylinder. The cylindrical body is configured to be rotated about its longitudinal axis so that, to the viewer, a reflection of the images “hovers” just above the underlying images; and the spinning (or “flipping”) of the facets produces a “shutter-like” effect such that each reflected image is replaced by an adjacent one of the series of motion-picture images (to produce a magical animated effect).

Note this method and apparatus for displaying motion pictures eliminates the need for film or video/new media equipment, allows a viewer to observe motion picture images from a wide variety of viewing angles (without using mirrors), and eliminates the need for a clear cylinder—this enables one to create, for example, a low-cost animation novelty (with new and improved qualities). Additional features and benefits of the present invention will become apparent from the detailed description, figures and claims set forth below.

### BRIEF DESCRIPTION OF THE SEVERAL VIEWS OF THE DRAWING

The present invention is illustrated by way of example and not limitation in the accompanying figures.

FIG. 1A is a perspective view of a motion picture display device with a rotatable base or top in accordance with the teachings of the present invention.

FIG. 1B is a top view of a motion picture display device in FIG. 1A, in accordance with the teachings of the present invention.

FIG. 2A is a perspective view of a motion picture display device with rotatable facets in a pinwheel formation.

### DETAILED DESCRIPTION OF THE INVENTION

A method and an apparatus for displaying motion pictures is disclosed. In the following description, numerous specific details are set forth in order to provide a thorough understanding of the present invention. It will be apparent, however, to one having ordinary skill in the art that the specific detail need not be employed to practice the present invention. In other instances well known material or methods have not been described in detail in order to avoid obscuring the present invention.

The present invention provides a method and an apparatus for displaying motion pictures by providing a series of motion picture designs or images that are applied or closely positioned to each facet of a pinwheel or faceted-cylinder, which when lit and rotated produces an animated effect for display. The rotating of the present invention allows for a reflection of the images to “hover” just above the underlying images, as the spinning (or “flipping”) of the facets produces a “shutter-like” effect such that each reflected image is replaced by an adjacent one of the series of motion-picture images (to produce a magical animated effect). The present invention allows for various speeds of rotation, providing from slow to fast animation. The present invention also allows for wide variety of lighting (from which to generate a reflection of the underlying images). The images animated with the present invention can be viewed from a large number of angles and from any practical distance.

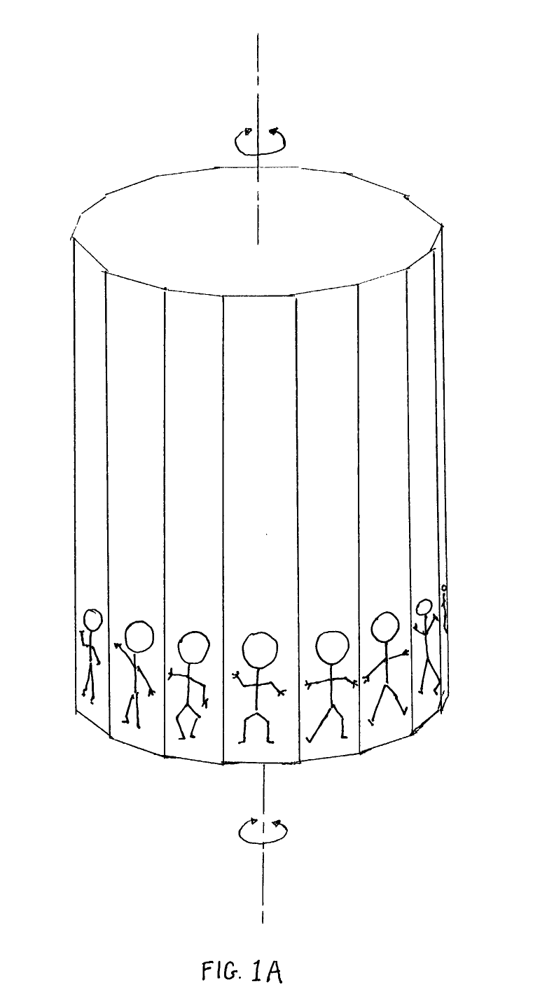

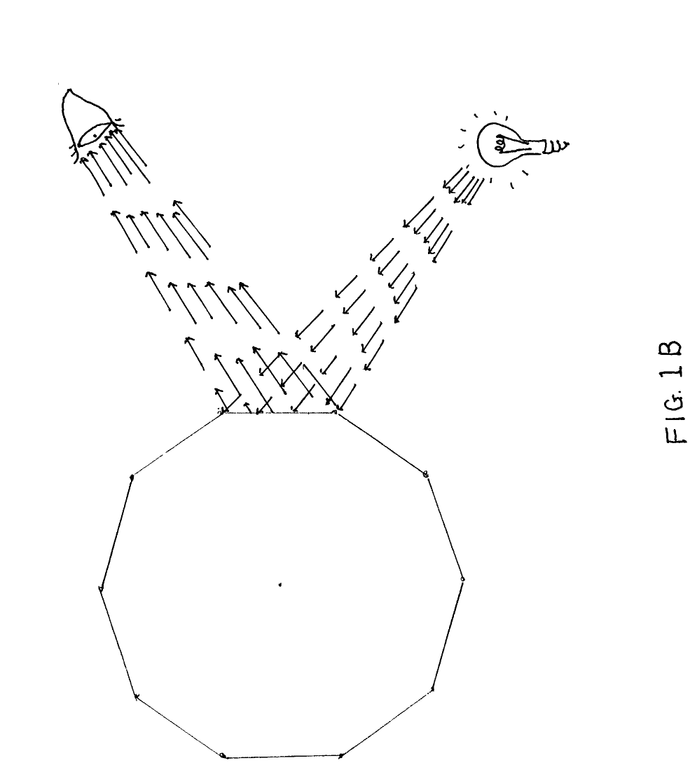

FIG. 1A shows a perspective of the presently best-contemplated mode for the present invention, that includes a cylindrical body with vertical facets, and motion picture images disposed substantially near corresponding facets (in a series). In this embodiment, the images are substantially flat against a glossy background, with a reflected light source cast upon them. The cylinder is made to be rotated about its longitudinal axis (from the top or the bottom, and with or without mechanization), so that to the viewer, a reflection of the images “hovers” just above the underlying images; and the spinning (or “flipping”) of the facets produces a “shutter-like” effect such that each reflected image is replaced by an adjacent one of the series of images (to produce a magical animated effect).

In this embodiment of the present invention, the series of images are attached directly to the surface of each of the facets of the cylinder (which itself may be clear or opaque, and with any of a number of facets). Some methods for attaching images directly to the cylinder include well known techniques such as, but not limited to, painting, printing, etching, decaling, or the like. In another embodiment of the present invention, the series of images may be objects positioned substantially near the surface of each facet using well-known techniques. Further, in yet another embodiment of the present invention, the series of images may be detachable (for replacement or layering, or as in a reel of long-running images that only runs over underlying facets moving at a speed synchronized to the reel of images).

FIG. 1B shows a top view of the same embodiment shown in FIG. 1A.

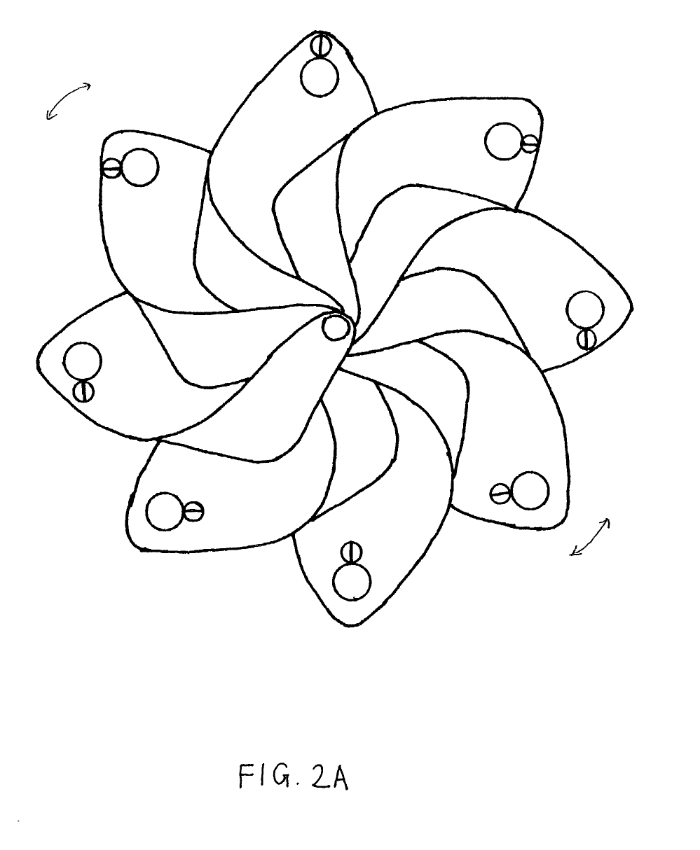

FIG. 2A shows a perspective view of another embodiment of the present invention, that includes a motion picture display device with rotatable facets in a pinwheel formation. In this embodiment, images are substantially flat against a glossy background, and there is a reflected light source cast upon them. The pinwheel is configured to be rotated (with or without a motor), so that to the viewer, a reflection of the images “hovers” just above the underlying images; and the spinning (or “flipping”) of the facets produces a “shutter-like” effect such that each reflected image is replaced by an adjacent one of the series of motion-picture images (to produce a magical animated effect).

Thus, what has been described is a method and apparatus for displaying a motion picture. With the presently described motion picture display device, motion pictures can be displayed without the use of film or video/new media, thereby avoiding the costs and complexities associated with them. Further, the motion picture images can be viewed from a broad range of speeds, angles, distances and lighting conditions (and without the use of mirrors or clear cylinders).

In the foregoing detailed description, the method and the apparatus of the present invention has been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

What I claim as my invention is:

1. A motion picture display device, comprising:
a faceted body, wherein the facets are substantially visible to an onlooker (such as facets on a cylinder or pinwheel); and
a series of images, wherein each one of the series of images are disposed substantially near a corresponding facet, such that each one of the series of images is visible to an onlooker (such as on the facets of a cylinder or pinwheel); and
a source of light cast upon the images;
wherein the faceted body is configured to be rotated about its axis such that each one of the series of images emits a reflection that “hovers” just above the underlying images; and the spinning (or “flipping”) of the facets produces a “shutter-like” effect such that each reflected image is replaced by an adjacent one of the series of motion-picture images (to produce a magical animated effect).

2. The motion picture diplay device described in claim 1 wherein the series of images are 2 dimensional.

3. The motion picture diplay device described in claim 1 wherein the series of images are 3 dimensional.

4. The motion picture diplay device described in claim 1 wherein the series of images are affixed to a corresponding facet.

5. The motion picture diplay device described in claim 1 wherein the series of images are detachable (as in a reel of long-running images that only runs over underlying-facets moving at a speed synchronized to the reel of images).

6. A method for viewing motion pictures, comprising the steps of:
providing a faceted body, wherein the facets are substantially visible to an onlooker (such as facets on a cylinder or pinwheel); and
disposing a series of images, wherein each one of the series of images are substantially near a corresponding facet, such that each one of the series of images is visible to an onlooker (such as on the facets of a cylinder or pinwheel); and
a source of light cast upon the images; and
the faceted body is configured to be rotated about its axis such that each one of the series of images emits a reflection that “hovers” just above the underlying images; and the spinning (or “flipping”) of the facets produces a “shutter-like” effect such that each reflected image is replaced by an adjacent one of the series of motion-picture images (to produce a magical animated effect).

7. The method described in claim 6 wherein the series of images are 2 dimensional.

8. The method described in claim 6 wherein the series of images are 3 dimensional.

9. The method described in claim 6 wherein the series of images are affixed to a corresponding facet.

10. The method described in claim 6 wherein the series of images are detachable (as in a reel of long-running images that only runs over underlying facets moving at a speed synchronized to the reel of images).
